(19) United States
(12) Patent Application Publication
(10) Pub. No.: US 2011/0104913 A1
(43) Pub. Date: May 5, 2011

(54) Edge card connector having solder balls and related methods

(76) Inventor: Jonathan R. Hinkle, Raleigh, NC (US)

(21) Appl. No.: 12/590,090

(22) Filed: Nov. 2, 2009

(51) Int. Cl. H01R 12/00

(52) U.S. Cl. 439/68; 439/65

(57) ABSTRACT

An edge card connector includes: a substantially rigid, insulating housing having internal electrical contacts to engage the edge of a first circuit board inserted into the housing; solder balls arranged on an outer surface of the housing in a selected pattern to establish connections to corresponding conductive pads on a second circuit board when the solder balls are at least partially melted; and, electrical connections between the internal electrical contacts and the solder balls. The socket may contain additional features for added strength, ease of assembly, and other purposes. The system is assembled by placing the socket onto a circuit board, aligning the solder balls with respective contact pads, and fusing the solder balls to establish electrical connectivity. A standoff structure may be provided to avoid excessive compaction of the solder balls.

### CROSS-REFERENCE TO RELATED APPLICATION

This application claims the benefit of Provisional Patent Application No. 61/009,781 by the present inventor, filed on Nov. 2, 2008, the entire disclosure of which is incorporated herein by reference.

### BACKGROUND OF THE INVENTION

1. Field of the Invention

The invention pertains to circuit board connectors. More particularly, the invention pertains to edge card connectors having solder balls and related methods of assembly.

2. Description of Related Art

In modern computer systems, the main memory sub-system often uses pluggable memory modules. These are generally printed wiring boards (PWBs) with memory devices mounted on them, and are called dual inline memory modules (DIMMs); they interface with memory sockets that are mounted on the main computer PWB. The most widely adopted interface and interconnect for these pluggable modules and sockets is the “card edge” (aka “edge card”) PWB module and socket interface method. Modern computer systems use these DIMM sockets to allow a variety of DIMM sizes, speeds and configurations to be plugged into the same main computer system board, allowing a wide range of configurable options as well as easy DIMM replacement either for upgrade or to replace a failed component.

The most common DIMM sockets currently employed can be referred to as “solder tail,” “press-fit,” and “surface mount”. All of these types are currently used in computer systems. “Solder tail” DIMM sockets have card edge pins bent within a non-conductive housing or shroud and interface to copper pads on the DIMM to make electrical connections. The pins then extend below the bottom of the socket and are inserted into corresponding holes drilled in the main computer board. The pins are then soldered into these holes to make electrical connection. A similar technology for DIMM sockets is commonly referred to as “press fit”. These DIMM sockets are similar to “solder tail” sockets, but instead of being soldered into the plated holes in the main computer system board, they are pressed into more narrow plated holes. The conductive pins protruding from the bottom of the “press-fit” socket appear like an eyelet, which is intentionally crushed as it is inserted into the hole making connection with the computer system board. At high frequencies used today both of these technologies have poor electrical performance inherent to the method of their design. The pins protrude at least all the way through the computer system board, which creates a capacitive stub. This unwanted capacitance is deleterious to high speed digital signaling in computer system design. These two DIMM socket technologies also make adding signals to evolutionary memory busses much more difficult. Making them smaller pitch to fit more pins into the same space can cause significant manufacturing issues. In addition these two DIMM socket technologies may require manual insertion into the PWB board plated holes to avoid bent pins during assembly and may be difficult to remove from the PWB board for rework should the socket become damage through mishandling. It also would greatly reduce the computer system board's area for routing memory signals and power through DIMM sockets, which is usually a system design requirement. The third type of DIMM socket, here referred to as “surface mount”, generally comprises gull-wing pins that are bent outward from the center housing of the pins and card edge interface. This technology allows the DIMM socket to sit on the surface of the computer system board by soldering the gull-wing pins from the DIMM socket to corresponding pads on the computer system board. This socket has better electrical performance for high-speed memory busses than “solder tail” and “press fit” sockets because of the lack of capacitive stub past the electrical connection with the computer system board's signal trace. However, the “surface mount” socket also has electrical performance issues. Because of the long gull wing pin contacts, the inductance of the socket interconnect is still high. Thus, these sockets are still not sufficient for supporting the evolutionary increase of high-speed digital signaling rates for modular main memory sub-systems. Additionally, the pad and gull-wing pin method of attaching to the computer system board makes additional interconnect more difficult as well, reducing signal effectiveness and power delivery to the DIMM.

In view of the foregoing problems and deficiencies associated with current edge card connectors, it is desirable to provide improved edge connectors and related methods.

### Objects and Advantages

Objects of the present invention include the following: providing edge card connectors having solder balls and related methods; providing edge card connectors having improved signal performance; and, providing a means of mounting edge card connectors with improved rigidity and reliability. These and other objects and advantages of the invention will become apparent from consideration of the following specification, read in conjunction with the drawings.

### SUMMARY OF THE INVENTION

According to one aspect of the invention, an edge card connector comprises:

a substantially rigid, insulating housing having a plurality of internal electrical contacts configured to engage the edge of a first circuit board inserted into the housing;

a plurality of solder balls arranged on an outer surface of the housing in a selected pattern to establish connections to corresponding conductive pads on a second circuit board when the solder balls are at least partially melted; and,

electrical connections between the internal electrical contacts and the solder balls.

According to another aspect of the invention, an edge card connector system comprises:

a socket comprising a substantially rigid insulating housing having a plurality of internal electrical contacts, the electrical contacts further connected to a plurality of external solder balls;

a first circuit board comprising a plurality of conductive pads configured to engage edge-wise with the socket and with the internal electrical contacts; and,

a second circuit board comprising a plurality of conductive pads configured to engage with the external solder balls and form electrical connections to the first circuit board when the solder balls are at least partially melted.

According to another aspect of the invention, a method for assembling an edge card connector and a circuit board comprises the steps of:

a) providing an edge card connector comprising: a substantially rigid insulative housing having a plurality of internal electrical contacts configured to engage the edge of a first circuit board inserted into the housing; a plurality of solder balls arranged on an outer surface of the housing in a selected pattern to establish connections to corresponding conductive pads on a second circuit board when the solder balls are at least partially melted; and, electrical connections between the internal electrical contacts and the solder balls;

b) placing the edge card connector onto the second circuit board with the solder balls in contact with their respective conductive pads; and,

c) heating the solder balls to a temperature sufficient to at least partially melt the solder balls so that electrical communication may be established between the second circuit board and the internal electrical contacts.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawing figures, wherein like numerals (if they occur in more than one view) designate the same elements. The features in the drawings are not necessarily drawn to scale.

FIG. 1 is a front view and a partial bottom view of an edge card socket according to one example of the invention;

FIG. 2 is a bottom view of the edge card socket shown in FIG. 1;

FIG. 3 is a side cross-sectional view of an edge card socket according to one example of the invention;

FIG. 4 is a side cross-sectional view of an edge card socket according to one example of the invention;

FIG. 5 is a side cross-sectional view of an edge card socket according to one example of the invention;

FIG. 6 is a side cross-sectional view of an edge card socket and a circuit board plugged into the edge card socket according to one example of the invention;

FIG. 7 is a side cross-sectional view of an edge card socket having a support structure according to one example of the invention;

FIG. 8 is a side cross-sectional view of an edge card socket having a support structure according to one example of the invention; and

FIG. 9 is a top view of an edge card socket having a support structure according to one example of the invention.

### DETAILED DESCRIPTION OF THE INVENTION

According to one example of the invention, an edge card connector can include a housing comprising a substantially rigid, insulative portion, preferably made of a dielectric material such as thermoplastic or other suitable nonconductive material. The edge card connector can also include a plurality of solder balls connected to contacts or conductive pads on the insulative portion of the housing in a selected pattern for engaging corresponding conductive pads on a circuit board such that an electrical connection is established between the solder balls and the conductive pads when at least a partially melted portion of each solder ball is contacting a respective conductive pad.

In an exemplary edge card connector in accordance with the invention, an edge card connector may have one or more solder balls or a ball grid array (BGA) interconnect for electrically coupling to a circuit board. The socket may have one or more rows of solder balls across the length of the socket, which interface to pads on a computer system board (“motherboard”) or other circuit board. During board assembly, the socket is attached to the board by suitably melting the solder balls, thereby connecting the melted portion of the solder balls to the board pads for electrically coupling the edge card connector to the circuit board.

In another example, an edge card connector or the circuit board may include mechanical features or structures for preventing too much compaction of solder balls when the edge card connector is attached to the circuit board. For example, either the edge card connector or the circuit board may include one or more standoff structures positioned between a housing of the edge card connector and the circuit board when assembled together. The standoff structures may have sufficient dimensions and rigidity for preventing substantial compaction of the solder balls during assembly of the edge card connector system. The standoff structures can be suitably dimensioned, positioned and rigid for preventing mechanical damage to connection of the solder balls to the circuit board pads as well as other structures of the circuit board and edge card connector.

In another example, an edge card connector or the circuit board may include one or more support structures for preventing substantial movement of the edge card connector with respect to the circuit board. For example, the support structures may prevent substantial rotation stress of the edge card connector with respect to the circuit board. In one example, the support structures may be mechanical stabilizing wings suitably designed to prevent socket rotation after attachment.

The inventive edge card connector may include one or more conductive springing pins electrically coupled to the solder balls. The edge card connector may include one or more conductive pads corresponding to the springing pins. The conductive pads may be electrically coupled by attachment or other suitable technique to corresponding solder balls. As a result, the solder balls may be in electrical communication with the springing pins via the conductive pads. In one example, the conductive pins are bent metallic pins for providing spring force for contact with the card edge pads on a module, such as a DIMM. In this example, the pins can electrically interface to metal pads at the bottom of the insulative housing of the edge card connector, which has solder balls attached below them.

In another example of the invention, an edge card connector is assembled with a circuit board by providing an edge card connector having a housing comprising a substantially rigid, insulative portion 3. The edge card connector may include electrical connection components and one or more solder balls connected to contacts or conductive pads on the housing in a predetermined pattern. The solder balls are electrically coupled to the electrical connection components. The assembly process includes heating the solder balls to within a predetermined temperature range for melting at least a portion of the solder balls. The melted portion of the solder balls are thereby connected to a plurality of corresponding conductive pads of a circuit board.

Referring now to the Figures, an edge card socket in accordance with the invention may have a plurality of solder balls 11 positioned on a bottom edge of the socket and in contact with metal pads or pins in the socket. Exemplary solder balls can range in size between about 500 μm to about 1000 μm. Solder balls 11 are configured to make contact with metal pads correspondingly positioned on a main PWB. Solder balls 11 are attached to the bottom pads or leads of the spring pins by one of several methods. The solder balls may be preformed and placed into a mold to properly separate them apart at the proper pitch before they are gang bonded to the pads or leads using heat transfer from the connector or mold. Alternatively, the solder may be jetted onto the surface of the pads or leads or stencil printed and reflowed in place. A variety of other methods are commonly employed to attach solder balls to an array of pads on PWB interposer substrates, as are well known within the industry, and may also be employed for this process step. The solder balls 11 can be attached by at least partially melting the solder balls and contacting them to their corresponding metal pads on the PWB.

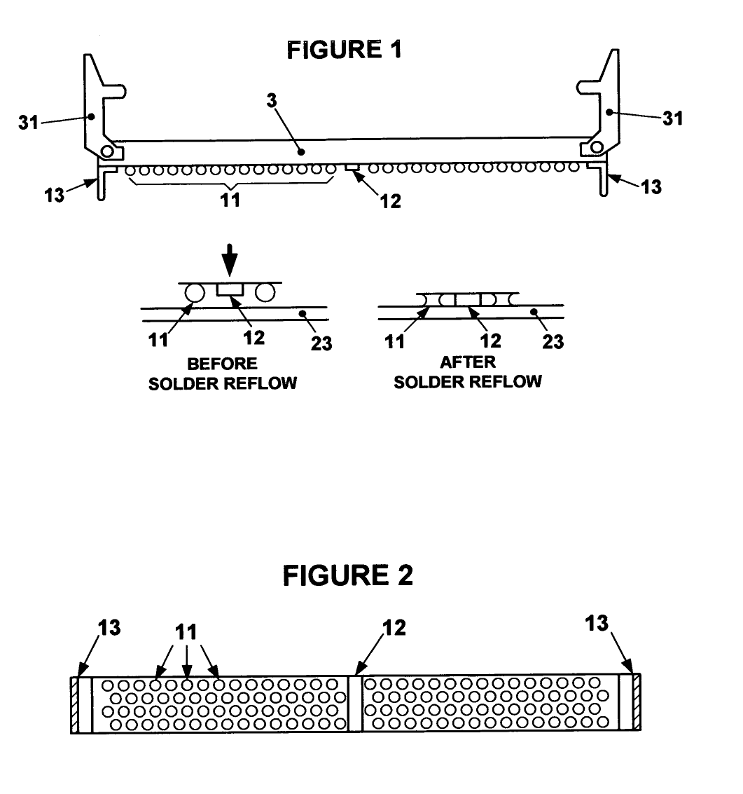

Referring to FIGS. 1 and 2, one or more standoff structures 12, 13 may be attached to, or integral with, the edge card connector for preventing mechanical damage to the solder balls. For example, the edge card connector can include a center standoff structure 12 and side standoff structures 13. Once the connector is attached, solder balls 11 can be collapsed or compacted to a height in the range of about 400 μm to about 750 μm. The standoff structures can be sized about the same as the compacted height of the solder balls to prevent too much compaction of the solder balls. For example, the standoff structures can prevent further stress of force vertically down on the solder balls in during both assembly and module insertion. This result is accomplished because the standoff structures 12, 13 are positioned between the edge card connector and the circuit board 23, and their rigidity, size and position prevent the movement of the edge card connector to a distance towards the circuit board such that the solder balls would be compacted too much. In this example, three standoff structures are shown, but any number, size, dimension, material, and positioning of the standoff structures may be used in order to accomplish the above described objective. If the insulative portion 3 of the connector is injection molded plastic, the standoff structures may be formed as an integral part of the injection molding to minimize manufacturing cost and complexity.

The standoff structures are preferably dimensioned at about 50% to about 75% of the solder ball height. For solder balls preferably in the range of about 200 μm to 1000 μm in diameter, the standoff structure would preferably be approximately 150 μm up to 600 μm in height to prevent ball damage.

The edge card connector may also include latches 31 attached to a side thereof for engaging a module board, such as a memory board or DIMM, that has been inserted into the edge card connector. The latches 31 may serve many purposes including securing the memory module into the edge card connector and preventing them from losing electrical contact with the connector pins. The latches can do this by a protrusion block of the latch moving into a notch on the modular memory board. The latches may also have a mechanism to rotate at the hinge and dislodge or eject the memory module from the edge card connector, and may have a spring mechanism to engage them more securely when a module is in place. Alternatively, latches 31 may be integral with insulative portion 3 and have sufficient mechanical compliance to flex elastically in order to engage or disengage the module.

Referring to FIG. 2, solder balls 11 are shown in a ball grid array configuration. The solder balls can be placed in several rows and/or diagonally staggered to increase pin count density as is well known in the art.

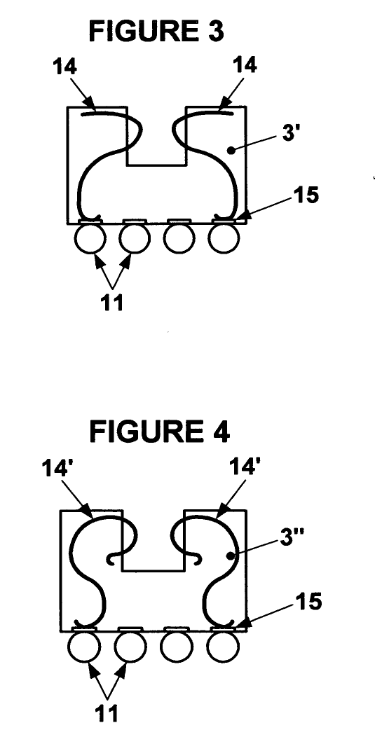

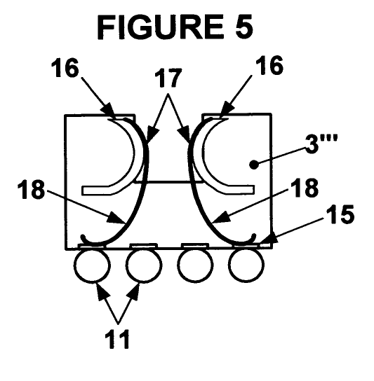

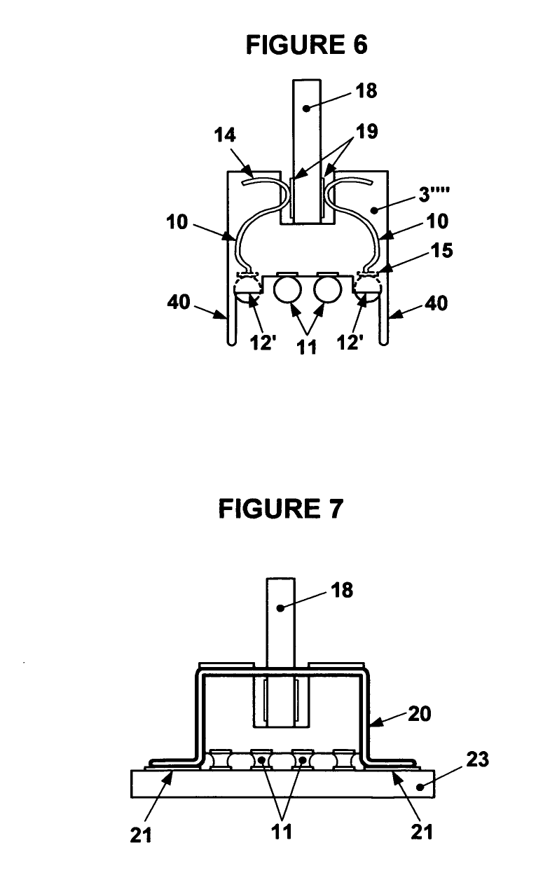

Referring now to FIGS. 3-6, an edge card connector in accordance with the invention includes an insulating housing 3, 3′, 3″, 3′″, or 3″″ (as shown in FIGS. 3-6), which is configured to receive a module (such as board 18 shown in FIG. 6). The non-conductive housing of the edge card connector, generally designated 3, can include a plurality of conductive springing pins. In FIG. 3 for example, housing 3′ can include curved conductive pins 14. In FIG. 4 for example, housing 3″ can include curled conductive pins 14′. In FIG. 5 for example, housing 3′″ can include flexible circuit 18 with exposed surface contact areas 17 pressed against the module's pads 19 by mechanical springs 16 behind the flex. In FIG. 6 for example, housing 3″ can include S-shaped springing pins 10. Internal conductive pins may be physically connected to pads 19 by soldering, by a press-fit connection, or other suitable means as are well known in the art.

As shown in FIG. 6, insulative housing 3″″ may be further modified to include downwardly-projecting pins 40 that engage corresponding through-holes in the computer board 23 in order to provide a more secure assembly. Each pin 40 may be further provided with a shoulder 12′ to perform the stand-off function previously described for standoff structures 12 and 13. The pins not only serve to locate the socket prior to fusing the solder balls, but also provide mechanical support against deleterious movements such as displacement, twisting, rotation, or tilting of the socket relative to the underlying circuit board

The conductive springing pins can be attached to a conductive insert or pad 15 at the bottom of housing 3 and one or more solder balls 11 can be attached at the bottom of the housing 3 to the other side of this insert. The springing pins can be in electrical communication with pads 19 of module 18 when module 18 is suitably positioned within housing 3, and pads 19 contact their respective springing pins 10.

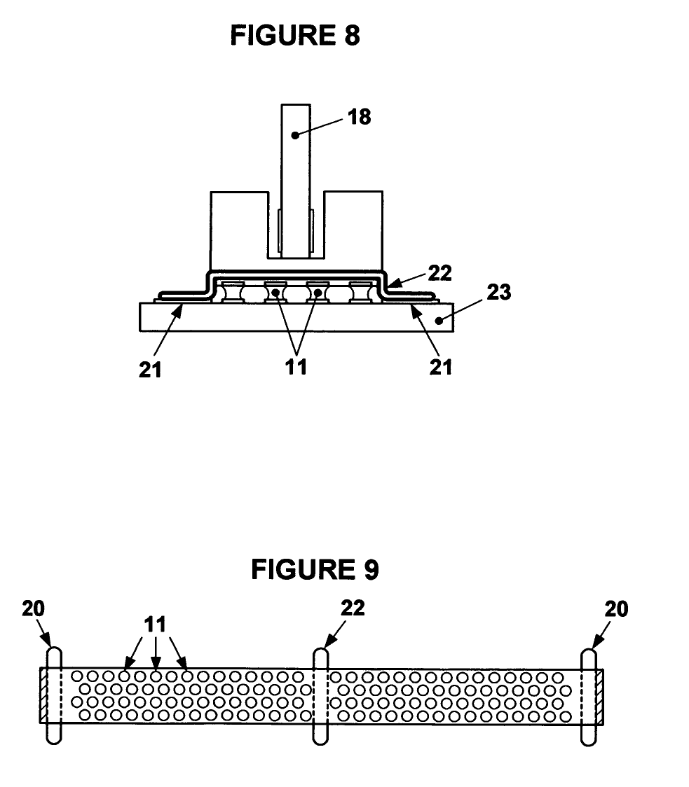

In another example of the invention, one or more rigid support structures or pins 20 may be inserted into, or integral with, the connector housing to prevent force normal to the connector's vertical alignment, which could cause rotation stress and damage to the socket solder balls. FIGS. 7-9 show different views of an edge card socket having support structures 20 and 22. The support structures can be made of a conductive material and soldered to pads 21 on the main computer system board 23 for additional rigidity as well as for additional electrical contact. Support structures 22 that are not at the ends of the connector can have less height to avoid interference with the module to be inserted. Alternatively, the module may be notched to eliminate mechanical interference and allow for full insertion of the module, with its board straddling the support structure. This feature could further be used as a key to prevent incompatible modules from being inserted into the connector. A circuit board pad 21 can be in contact with support structure 20. Alternatively, the support structures may be made of a suitable non-conductive material, and may be an integral part of the molded housing 3. They may also be secured to board 23. The support structures can prevent substantial movement of the edge card connector with respect to the circuit board, such as substantial rotational movement of the edge card connector with respect to the circuit board.

It will be understood that various details of the invention may be changed without departing from the spirit and scope of the invention as claimed. In particular, engineering details such as overall size and shape, number of pins, and various other dimensions may be modified by the skilled artisan for any particular application and/or to conform to any existing or future industry standards. The foregoing description is for the purpose of illustration only, and not for the purpose of limitation.

I claim:

1. An edge card connector comprising:
a substantially rigid, insulating housing having a plurality of internal electrical contacts configured to engage the edge of a first circuit board inserted into said housing;
a plurality of solder balls arranged on an outer surface of said housing in a selected pattern to establish connections to corresponding conductive pads on a second circuit board when said solder balls are at least partially melted; and,
electrical connections between said internal electrical contacts and said solder balls.

2. The edge card connector of claim 1 further comprising a standoff structure configured to maintain a selected spacing between said housing and said second circuit board when assembled together, said selected spacing being sufficient to prevent excessive compaction of said solder balls during assembly of the system.

3. The edge card connector of claim 2 wherein said selected spacing is between about 50% and 75% of the diameter of said solder balls.

4. The edge card connector of claim 1 further comprising a support structure configured to prevent substantial movement of said edge card connector with respect to said second circuit board.

5. The edge card connector of claim 1, wherein said rigid housing further comprises projections configured to engage through-holes in said second circuit board.

6. The edge card connector of claim 5 wherein said projections further comprise a standoff structure configured to maintain a selected spacing between said housing and said second circuit board when assembled together, said selected spacing being sufficient to prevent excessive compaction of said solder balls during assembly of the system.

7. The edge card connector of claim 1, wherein said internal electrical contacts comprise a plurality of conductive springing pins electrically coupled to said solder balls.

8. The edge card connector of claim 1 wherein said internal electrical contacts comprise a plurality of conductive pads on a flex circuit and said housing further comprises a mechanical spring configured to hold said flex circuit into contact with said first circuit board.

9. The edge card connector of claim 1 wherein said insulating housing further comprises a latching mechanism configured to engage said first circuit board and secure said first circuit board in said connector.

10. An edge card connector system comprising:
a socket comprising a substantially rigid insulating housing having a plurality of internal electrical contacts, said electrical contacts further connected to a plurality of external solder balls;
a first circuit board comprising a plurality of conductive pads configured to engage edge-wise with said socket and with said internal electrical contacts; and,
a second circuit board comprising a plurality of conductive pads configured to engage with said external solder balls and form electrical connections to said first circuit board when said solder balls are at least partially melted.

11. The edge card connector system of claim 10 wherein said first circuit board comprises a memory module.

12. The edge card connector system of claim 10, wherein said second circuit board comprises a computer motherboard.

13. The edge card connector system of claim 10, wherein said socket further comprises a standoff structure configured to maintain a selected spacing between said housing and said second circuit board when assembled together, said selected spacing being sufficient to prevent excessive compaction of said solder balls during assembly of the system.

14. The edge card connector system of claim 10 wherein said socket further comprises projections configured to engage through-holes in said second circuit board.

15. The edge card connector system of claim 10, wherein said insulating housing further comprises a latching mechanism configured to engage said first circuit board and secure said first circuit board in said connector.

16. A method for assembling an edge card connector and a circuit board comprising the steps of:
a) providing an edge card connector comprising:
a substantially rigid insulative housing having a plurality of internal electrical contacts configured to engage the edge of a first circuit board inserted into said housing; a plurality of solder balls arranged on an outer surface of said housing in a selected pattern to establish connections to corresponding conductive pads on a second circuit board when said solder balls are at least partially melted; and, electrical connections between said internal electrical contacts and said solder balls;
b) placing said edge card connector onto said second circuit board with said solder balls in contact with their respective conductive pads; and,
c) heating said solder balls to a temperature sufficient to at least partially melt said solder balls so that electrical communication may be established between said second circuit board and said internal electrical contacts.

17. The method of claim 16 wherein said first circuit board comprises a memory module.

18. The method of claim 16, wherein said second circuit board comprises a computer motherboard.

19. The method of claim 16 further comprising the step of:
d) providing a mechanical standoff structure configured to maintain a selected spacing between said housing and said second circuit board when assembled together, said selected spacing being sufficient to prevent excessive compaction of said solder balls during assembly of the system.

20. The method of claim 19 wherein said selected spacing is between about 50% and 75% of the diameter of said solder balls.
